(19) United States
(12) Patent Application Publication
(10) Pub. No.: US 2022/0314551 A1
(43) Pub. Date: Oct. 6, 2022

(54) CONTAINERS TO CONTROL HEAT DISSIPATION

(71) Applicant: Hewlett-Packard Development Company, L.P., Spring, TX (US)

(72) Inventors: Roger Fadurdo Orellana, Sant Cugat del Valles (ES); Ismael Fernandez Aymerich, Sant Cugat del Valles (ES); Pol Fornos Martinez, Sant Cugat del Valles (ES); Manuel Freire Garcia, Sant Cugat del Valles (ES); Salvador Sanchez Ribes, Sant Cugat del Valles (ES)

(21) Appl. No.: 17/753,449

(22) PCT Filed: Sep. 25, 2019
(86) PCT No.: PCT/US2019/052872

§ 371 Date: Mar. 3, 2022

(51) Int. Cl. B29C 64/393; B29C 64/255; B29C 64/153; B29C 64/205; B33Y 50/02; B33Y 30/00

(52) U.S. Cl. CPC B29C 64/393; B29C 64/255; B29C 64/153; B29C 64/205; B33Y 50/02; B33Y 30/00; B29C 2035/046

(57) ABSTRACT

A non-transitory machine-readable storage medium is encoded with instructions executable by a processor. The machine-readable storage medium includes instructions to modify data representing a three-dimensional object model, the three-dimensional object model for use in generating a three-dimensional object in a build chamber. The data is modified to include a container to substantially encapsulate contents of the build chamber comprising the three-dimensional object and non-solidified build material. A wall of the container comprises heat transfer control elements to control dissipation of heat from the contents of the container.

### BACKGROUND

A three-dimensional (3D) printer may generate a 3D object in a build chamber by forming a plurality of successive layers of a powdered or granular build material and selectively solidifying portions of each layer. In one technique each formed layer may have an energy absorbing fusing agent selectively applied to locations within the layer, based on a received 3D object model. Energy is then applied generally to the whole layer, and those portions of the layer where fusing agent was applied heat up sufficiently to melt and fuse to form, upon cooling and solidification, a layer of the object being generated.

Upon completion of the print process, the contents of the build chamber comprise the 3D object, surrounded by non-solidified powder. This may be referred to as a “cake”. The cake may then be removed from the build chamber, and the non-solidified powder removed from the cake, thus revealing the 3D object.

### BRIEF DESCRIPTION OF DRAWINGS

FIG. 1 is a schematic perspective view of a first example container, with its contents shown in partial cutaway;

FIG. 2 is a schematic diagram of an example 3D printer;

FIG. 3 is a schematic diagram of transfer of contents of an example build chamber to an example secondary chamber;

FIG. 4 is a perspective view of a portion of the container of FIGS. 1 and 3;

FIG. 5 is a schematic cross-section view of the example secondary chamber of FIG. 3 connected to an example airflow generator;

FIG. 6 is a schematic diagram of heat transfer of the example container of FIGS. 1 and 3 to 5;

FIG. 7 is a perspective view of a portion of a second example container;

FIG. 8 is a schematic diagram of heat transfer of the example container of FIG. 7;

FIG. 9 is a flowchart of an example method; and

FIG. 10 is a schematic block diagram of an example computer-readable storage medium.

### DETAILED DESCRIPTION

Examples of the present disclosure include a 3D printer comprising a receiving section to receive a build unit. The build unit may have a build chamber, in which an object may be formed. In some examples, the build unit is a removable build unit, which may be attached and detached from a receiving section of the 3D printer. In other examples, the build unit may be integral to the 3D printer. The 3D printer may also comprise a build material distributor to distribute build material to the build chamber, a print unit to selectively apply a fusing agent to the build material, and a fusing unit to melt the fusing agent and fuse the fusing agent with the build material to form a 3D object in the build chamber; and a print control unit to control the print unit and fusing unit to form the 3D object. The print control unit may control the print unit and fusing unit to form the 3D object based on a received 3D object model.

The print control unit, which may for example comprise a processor and a memory, may control the print unit and fusing unit to form a container to contain the 3D object and non-solidified build material. The container accordingly acts as a receptacle or box which retains the 3D object and non-solidified build material.

In some examples, the print control unit controls the print unit and fusing unit to form the container, based on the received 3D object model. In other words, the received 3D object model comprises a 3D model of the container and a 3D model of the 3D object disposed therein. In some examples, the received 3D object model may not comprise a 3D model of the container. In such examples, the print control unit may generate a container to retain the 3D object and non-solidified build model.

After printing, the contents of the build chamber may be transferred to a secondary chamber attachable to the build chamber.

In some examples, a wall of the container comprises heat transfer control elements to regulate cooling of the contents of the container. In other words, the heat transfer control elements provide a predetermined thermal resistance. The heat transfer control elements may passively control dissipation of heat from the contents of the container, or a portion of the contents of the container proximate to the heat transfer control elements.

In some examples, the heat transfer control elements may provide a first level of thermal resistance. The first level of thermal resistance may be a relatively low level of thermal resistance. In other words, the heat transfer control elements act as a heat sink, and therefore cause more rapid cooling of the contents of the container than would be achieved if the heat transfer control elements were not present.

In some examples, the heat transfer control elements may provide a second level of thermal resistance, which may be greater than the first level of thermal resistance. The second level of thermal resistance may be relatively high level of thermal resistance. In other words, the heat transfer control elements may cause slower cooling of the contents of the container than would be achieved if the heat transfer control elements were not present. For example, the heat transfer control elements may be shaped to trap air between the wall of the container and a wall of the secondary chamber, so as to insulate the container.

The thermal resistance of the heat transfer control elements, and the related cooling rate of the 3D object may affect the material properties of the 3D object. For example, rapid cooling may increase material ductility. However, this may be at the expense of an increased likelihood of warpage, due to regions of the object cooling at different rates. Slower cooling may result in higher dimensional accuracy. However, this may be at the expense of more brittle parts.

In some examples of the disclosure, after transfer of the contents of the build chamber to the secondary chamber, the secondary chamber is connected to an airflow generator. The airflow generator may provide an airflow through the secondary chamber. The airflow may displace non-solidified build material disposed between the walls of the container and the walls of the secondary chamber. The airflow may be a cooled airflow. The airflow may be a heated airflow.

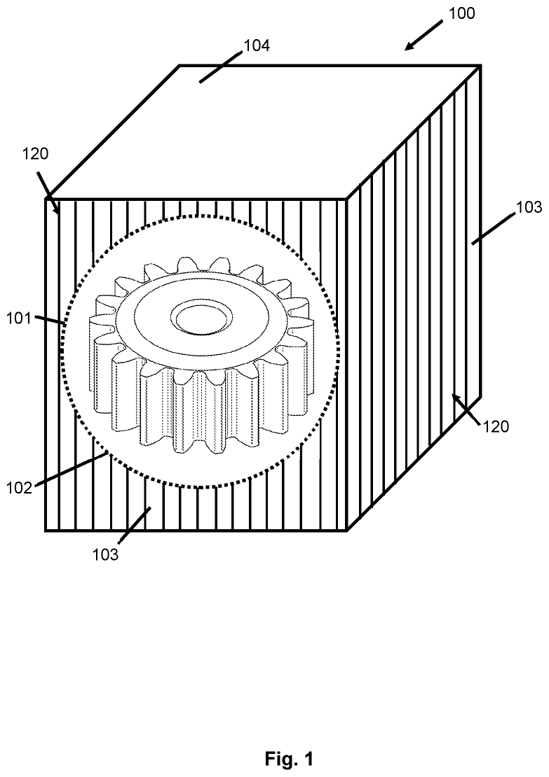

FIG. 1 shows an example container 100, which comprises a 3D object 101 and unsolidified powder 102. The container 100 may comprise a plurality of walls, for example including a plurality of side walls 103 and a top wall 104. Each wall is substantially planar. The walls enclose the 3D object 101 and the unsolidified powder. The side walls 103 may comprise heat transfer control elements 120, which will be discussed in further detail below.

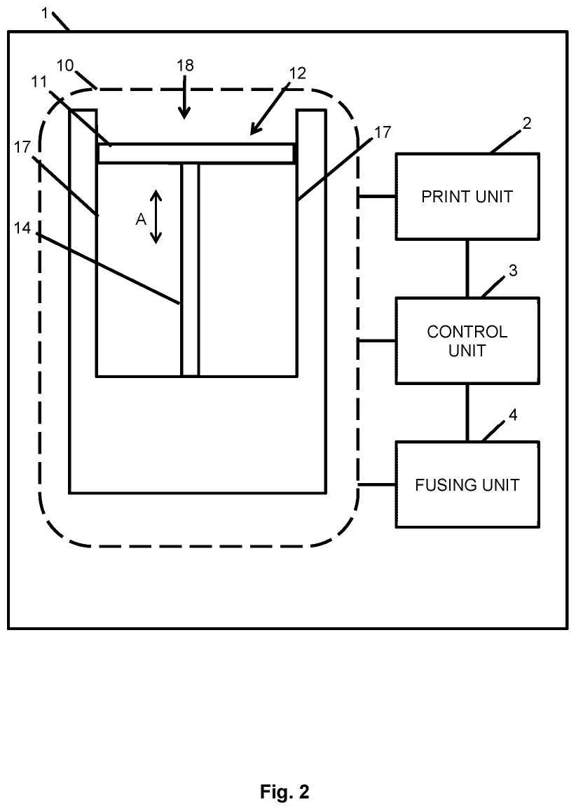

FIG. 2 shows an example 3D printer 1. The 3D printer 1 may be used to form a 3D object and a container, for example the 3D object 101 and container 100.

The 3D printer 1 comprises a print unit 2, a print control unit 3 and a fusing unit 4. The 3D printer 1 is also configured to receive a build unit 10. The build unit 10, which is shown in schematic cross-section in FIG. 1, may be a modular unit insertable into the 3D printer 1. However, in other examples, the build unit 10 may be integral to the 3D printer 1.

The build unit 10 comprises a build chamber, generally indicated by the reference number 12, in which the formation of the 3D object 101 and container 100 takes place. In one example, the build chamber 12 is a substantially cuboid volume defined in the interior of the build unit 10, formed by sidewalls 17. The build chamber 12 may have a substantially open top end 18.

The build chamber 12 comprises a movable platform 11, which may be configured to translate in a substantially vertical direction, as indicated by arrow A. The movable platform 11 may support a plurality of layers of build material within which the 3D object 101 and container 100 is produced. The moveable platform 11 forms a bottom of the build chamber 12 and is sealed around its edges to the sidewalls 17.

The build unit 10 may comprise an actuation mechanism 14 for translating the platform. In one example, the actuation mechanism comprises a drive screw. In further examples, the actuation mechanism 14 may comprise a scissor jack, a piston or any other suitable actuator.

The print unit 2 comprises any suitable elements to carry out 3D printing with the build unit 10. The print unit 2 may for example comprise a build material supply mechanism to deliver build material to the build chamber 12. The print unit 2 may comprise a fusing agent dispenser, to selectively deposit fusing agent to locations of the build material. The fusing agent may be an energy absorbing fusing agent. In some examples, the print unit 2 may comprise a detailing agent dispenser, to selectively deposit detailing agent to locations of the build material.

The fusing unit 4 may be to apply energy to a layer of build material, so as to cause melting of the fusing agent. The fusing agent may then, upon cooling, fuse with the build material to form a layer of the 3D object. The energy may be heat energy. In some examples, the fusing unit 4 may cause evaporation of the detailing agent.

The print control unit 3, which may comprise a processor and a memory, is to control the print unit 2 and fusing unit 4 in order to generate the 3D object 101 and container 100. In addition, the print control unit 3 is to control the build unit 10. In one example, the control unit 3 controls the moveable platform 11. The build unit 10 may interface with the 3D printer 1 in order to receive control signals from the control unit 3.

In one example, the print control unit 3 generates the 3D object 101 and container 100 based on a received 3D object model comprising models of both the 3D object 101 and container 100. For example, the model of the container may be added to the 3D object model by machine-readable instructions executed on a remote computing device, before the transmission of the 3D object model to the 3D printer 1. The machine-readable instructions may for example comprise CAD software or print pre-processing software.

In another example, the print control unit 3 may receive a 3D object model comprising a 3D model of the 3D object 101, and generate a container 100 to contain the 3D object 101.

In use, the print control unit 3 controls the print unit 2 and fusing unit 4 to deliver a layer of build material to the build chamber 12 and then form a layer of the 3D object 101 and container 100. Once the layer is formed, the print control unit 3 controls the build unit to vertically descend the platform 11 by the depth of a layer. The process is then repeated until all desired layers have been formed. Upon completion of the process, the contents of the build chamber 12 comprises the 3D object 101 and a substantial amount of unsolidified powder disposed in the container 100. The build unit 10 may then be detached from the printer 1.

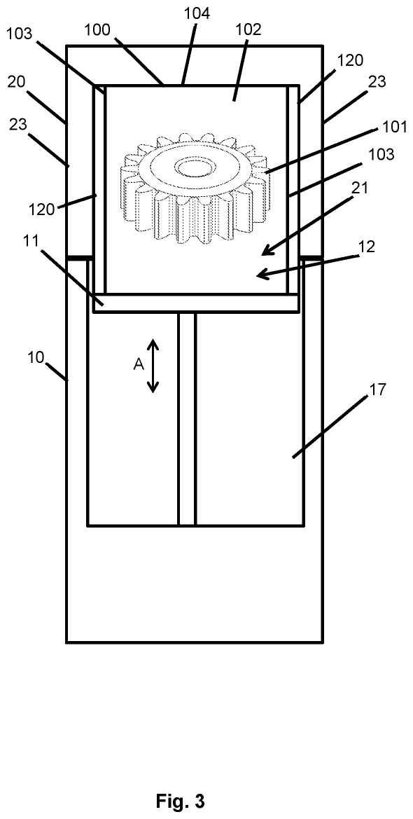

FIG. 3 illustrates the removal of the container 100 from the build unit 10 in schematic cross-section. As can be seen therein, secondary chamber 20, is attached to the build unit 10.

The secondary chamber 20 may comprise an enclosure. In one example, the secondary chamber 20 is cuboid in shape. The chamber comprises an open bottom end 21. The chamber comprises sidewalls 23. The bottom end 21 is configured to be placed in communication with the open top end 18 of the build unit 10. For example, the bottom of the secondary chamber 20 may attach to the top of build unit 10. Accordingly, upon ascent of the platform 11, the container 100, as well as the 3D object 101 and unsolidified powder 102 contained therein, are translated to the secondary chamber 20.

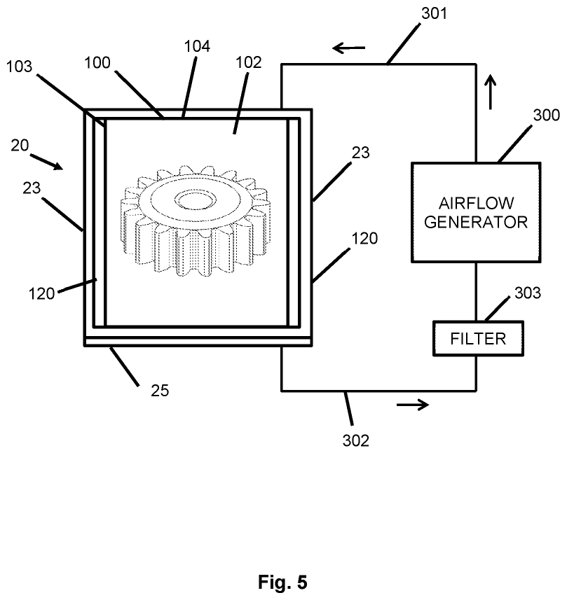

The secondary chamber 20 may be detached from the system 100 after receipt of the container 100, while retaining the container 100. For example, the secondary chamber 20 may be configured to receive a plate (25, see FIG. 5) whilst attached to the build unit 10, which seals the bottom end 21. Accordingly, the container 100 and its contents may be removed from the build unit 10.

In one example, the secondary chamber 20 is a cooling chamber. Therefore, the contents may be cooled separately, allowing the build unit 10 to be reused. In one example, the secondary chamber 20 is a natural cooling chamber. In other words, the secondary chamber 20 does not comprise a cooling mechanism, but instead provides a chamber in which the contents can be left to naturally return to ambient temperature. In further examples, the secondary chamber 20 comprises a cooling mechanism.

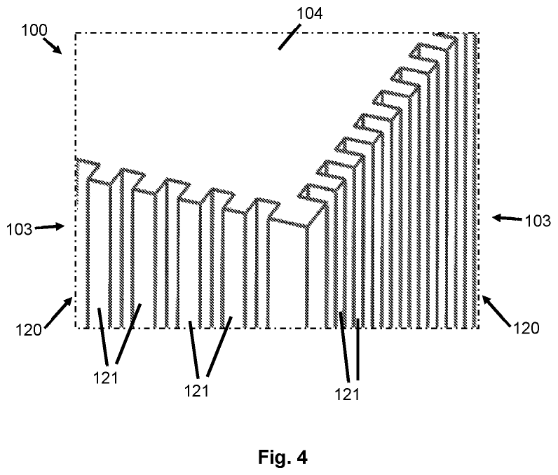

FIG. 4 illustrates the container 100 in more detail.

The container 100 has side walls 103 comprise heat transfer control elements, generally indicated by reference number 120. The heat transfer control elements 120 provide a predetermined level of thermal resistance. Accordingly, the heat transfer control elements 120 control dissipation of heat from the container 100. Particularly, the heat transfer control elements 120 may lower the thermal resistance of the container 100, and may thereby accelerate dissipation of heat from the container 100. Accordingly, the heat transfer control elements 120 act as a heat sink.

In the example of FIG. 4, the heat transfer control elements 120 comprise a plurality of fins 121 disposed on the exterior of the side walls 103. Not all of the fins 121 are labelled on FIG. 5, in order to preserve the clarity of the figure. The fins 121 are aligned in parallel substantially vertically. In one example, the gap between neighbouring fins 121 is approximately the same width as a fin 121. In one example, the fins 121 are each approximately from 2 to 8 mm wide, for example from 4 to 6 mm wide. In one example, the fins 121 are each 5 mm wide. In one example, the fins project from 10 to 20 mm from the wall 103, for example 13 to 17 mm from the wall. In one example, the fins project 15 mm from the wall. The fins 121 are arranged substantially vertically. The fins 121 are regularly spaced. Accordingly, the fins 121 increase the surface area available for heat exchange, in comparison to a container with a substantially planar wall.

FIG. 5 illustrates the example secondary chamber 20, connected to an airflow generator 300. The airflow generator 300 may be connected to the secondary chamber 20 so that the airflow generator 300 is in fluid communication with the interior of the secondary chamber 20 in order to induce an airflow therethrough.

For example, the airflow generator 300 may be connected to the secondary chamber 20 via conduits 301 and 302, which may take the form of a hose or pipe. Conduit 301 may be connected to a first port of the secondary chamber 20, with conduit 302 being connected to a second port of the secondary chamber.

The airflow generator 300 may for example comprise a fan and a motor for driving the fan, so as to generate an airflow. Accordingly, air may circulate from the airflow generator 300, through conduit 301, through the secondary chamber 20, and through conduit 302 back to the airflow generator 300. Accordingly, the airflow generator 300 may circulate air through the secondary chamber 20.

The airflow generator 300 may be to displace non-solidified build material disposed between the wall 103 of the container 100 and the wall 23 of the secondary chamber 20. For example, the airflow may cause non-solidified build material disposed between the fins 121 to become dislodged, and then removed from the secondary chamber 20. A filter 303 may be disposed along the outlet conduit 302, to capture the displaced non-solidified build material.

In one example, the airflow generator 300 may cool the airflow. In another example, the airflow generator 300 may heat the airflow.

In use, the secondary chamber 20 is detached from the build unit 10 and then connected to the airflow generator 300. The airflow generator 300 is activated, and dislodges any non-solidified material disposed between the side walls 103 of the container and the wall 23 of the secondary chamber, including any non-solidified material disposed between the fins 121. The non-solidified build material may be captured by the filter 303. In some examples, the airflow generator 300 may then continue to circulate air through the secondary chamber 20, to assist in increasing the cooling of the contents of the container 100.

Once cooled, the secondary chamber 20 may be transported to a post processing station. The container 100 is then removed from the secondary chamber 20. The container 100 is then broken, and the 3D object 101 extracted therefrom.

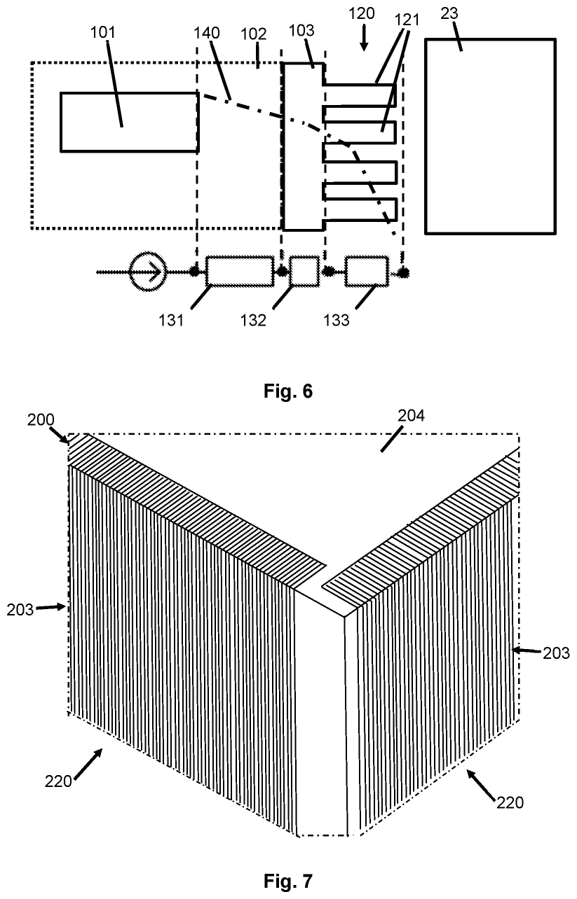

FIG. 6 illustrates the different thermal resistances encountered as heat transfers away from the 3D object 101 to the external environment beyond the secondary chamber 20, via the wall 103 of the container 100. The curve 140 and blocks 131-133 are overlaid on the schematic representation of the container 100 to show the rate of thermal transfer. As can be seen from the figure, the unsolidified powder 102 insulates the component in block 131. The wall 103 of the container offers thermal resistance as represented by block 232. However, the heat transfer control elements 120 lower the thermal resistance by providing an increased surface area for heat exchange. This may facilitate more rapid heat exchange, and thus offer a lower heat resistance in block 133. Accordingly, more rapid cooling occurs.

FIG. 7 illustrates another example container 200. The container 200 is similar to container 100 and may also be formed by 3D printer 1, and therefore a description of corresponding features is not repeated. Corresponding features have the same reference numbers, incremented by 100.

Like container 100, the container 200 has side walls 203 that comprise heat transfer control elements, generally indicated by reference number 220. The heat transfer control elements 220 provide a predetermined level of thermal resistance. Accordingly, the heat transfer control elements 220 control dissipation of heat from the container 200. Particularly, the heat transfer control elements 220 may slow dissipation of heat from the container 200.

In the example of FIG. 7, the heat transfer control elements 220 comprise a plurality of fins 221 disposed on the exterior of the side walls 203. The fins 221 are thinner than the fins 121 of container 120. For example, each fin is less than 2 mm wide, for example less than 1 mm wide, for example 0.5 mm wide. The fins 221 do not substantially increase the surface area available for heat exchange. However, the fins 221 serve to trap air between the wall 23 of the secondary chamber 20 and the container 200. The fins 221 may also obstruct air flowing around the container 200. For example, the fins 221 may extend to contact the wall 23 of the secondary chamber 20, so as to interfere with any air flow passing the container 200. Accordingly, an insulating air gap is created.

In use, the container 200 is generated by the 3D printer 1, transferred from the build unit 10 to the secondary chamber 20, and connected to the airflow generator 300 as discussed above. The airflow generator 300 generates an airflow to displace any non-solidified build material disposed between the fins 221. The airflow generator 300 may then be deactivated, so that a substantially still layer of air is trapped between the fins 221 as discussed above. In other examples, the airflow generator 300 may generate a heated airflow, which may pass over the heat transfer control elements 220 and decrease the cooling rate.

Once cooled, the secondary chamber 20 may be transported to a post processing station. The container 200 is then removed from the secondary chamber 20. The container 200 is then broken, and the 3D object 201 extracted therefrom

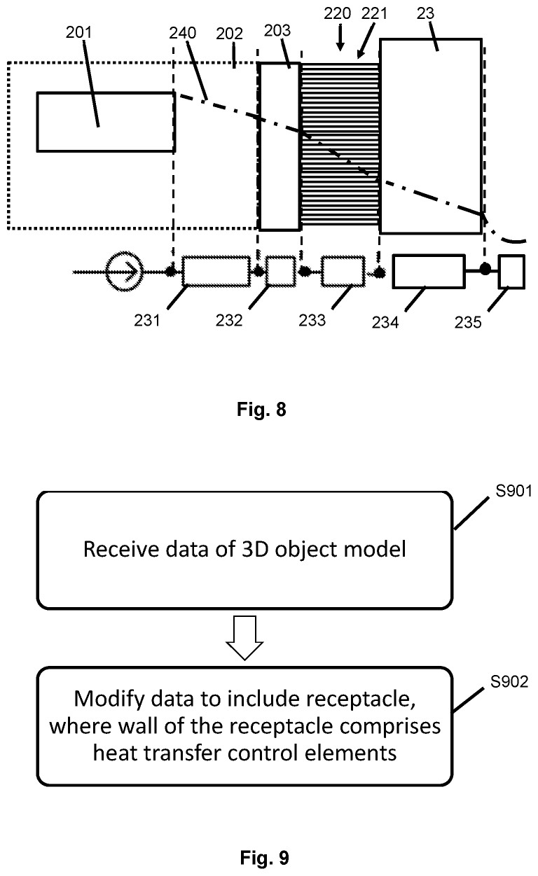

FIG. 8 illustrates the different thermal resistances encountered as heat transfers away from the 3D object 201 to the external environment beyond the secondary chamber 20, via the container 200. The curve 240 and blocks 231-235 are overlaid on the schematic representation of the container 200 to show the rate of thermal transfer. As can be seen from the figure, the unsolidified powder 202 insulates the component 201 in block 231. The wall 203 of the container 200 offers thermal resistance as represented by block 232. Furthermore, the fins 221 trap air, thus providing a degree of thermal resistance as represented by block 233. Subsequently, heat dissipates through the wall 23 as represented by block 234, before reaching the external environment in block 235.

Whilst the examples of FIGS. 1 and 3-8 show vertically aligned, regularly spaced and substantially straight fins, a variety of other heat transfer control elements may be employed in other examples. In some examples, the fins may be aligned in a direction other than vertical, for example horizontal or diagonal. In other examples, they may be irregularly spaced, or be curved or flared. In some examples, the heat transfer control elements may comprise elements other than fins. For example, the heat transfer control elements may comprise projections, such as pins, or recesses.

FIG. 9 shows a method in accordance with an example of the disclosure.

In block 901, data of a 3D object model is received. For example, the data may be a suitable data file comprising a 3D object model of a 3D object that is to be printed.

In block 902, the data file is modified to include a 3D model of a receptacle. The receptacle is sized to contain the 3D object, as well as non-solidified build material that will be used when the 3D object is printed. A wall of the receptacle comprises heat transfer control elements, such as those described herein.

In one example, the receptacle is generated based on a print attribute of the printing process. That is to say, a user may set a print mode that prioritises a particular attribute in the printing process.

In one example, the user may set a print setting that maximises print throughput. In which case, rapid cooling of the 3D object is desired. In one example, the user may set a print setting that maximises part strength. In this case, rapid cooling of the 3D object may also be desired, to increase the ductility of the 3D object.

In another example, the user may set a print setting that maximises dimensional accuracy of the resulting 3D object. Accordingly, slower cooling may be desired, to assist in ensuring regions of the object cool at the same rate, thereby avoiding warpage of the 3D object.

The method may comprise selecting and generating the receptacle based on the print attribute. For example, a plurality of possible receptacle designs may be stored, with the receptacle most appropriate for the desired print attributes selected. Accordingly, a receptacle may be generated that includes heat transfer control elements that accelerate the dissipation of heat if improved throughput or part strength is desired. If dimensional accuracy is desired, a receptacle may be generated that includes heat transfer control elements that slow the dissipation of heat.

It will be understood that the print setting may be set in pre-print software or directly on the printer.

In one example, the method is executed by the 3D printer 1, for example the print control unit 3. However, in other examples, the method may be carried out by a computing device remote from the 3D printer. For example, the data file may be edited to include the receptacle in pre-print software executed on the computing device, such that the print control unit 3 receives data representing the 3D object model and the receptacle.

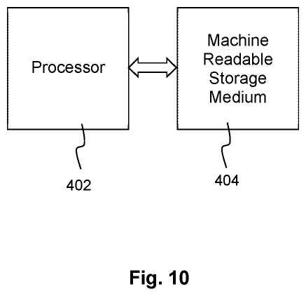

FIG. 10 shows an example non-transitory machine-readable storage medium 404 encoded with instructions executable by a processor 402.

The machine-readable storage medium may comprise instructions to modify data representing a three-dimensional object model, the three-dimensional object model for use in generating a three-dimensional object in a build chamber, to include a container to substantially encapsulate contents of the build chamber comprising the three-dimensional object and non-solidified build material. The container may be as described in the examples herein.

Various modifications may be made to the above-described examples. Whilst the examples above show heat transfer control elements formed on the side walls, in some examples heat transfer control elements may be additionally or instead formed on the top wall of the container. In some examples, the heat transfer control elements may be formed in the interior of the wall. For example, some regions of the walls may comprise internal cavities, in order to control heat dissipation. In some examples, some regions of the wall may be formed to be thinner or thicker than other regions of the wall in order to control heat dissipation.

Whilst the examples above show a substantially cuboid container, the shape of the container may be varied. For example, the container may be cylindrical, or any other shape able to retain the 3D object and non-solidified powder. In some examples, the container may be open at its top end. In other words, the container may not comprise a top wall. Accordingly, the container need not surround the object and powder on all sides. Heat transfer control elements may be formed on any number of the walls, for example a single one of the side walls or all of the side walls.

The examples above show the container containing substantially all of the non-solidified powder used in the printing process. In some examples, plural containers may be formed as part of the same print process, with each container containing a 3D object and non-solidified powder. In some examples, the container may contain a plurality of 3D objects.

The examples described herein allow generation of a container, which contains a 3D-printed object and surrounding non-solidified build material. The container comprises features which provide a desired heat transfer effect. Accordingly, upon completion of the printing process, the container and its contents may be readily removed from the build chamber, and for example stored in a secondary chamber, whereupon the printed object cools in the desired manner.

1. A non-transitory machine-readable storage medium encoded with instructions executable by a processor, the machine-readable storage medium comprising:
instructions to modify data representing a three-dimensional object model, the three-dimensional object model for use in generating a three-dimensional object in a build chamber, to include a container to substantially encapsulate contents of the build chamber comprising the three-dimensional object and non-solidified build material,
wherein a wall of the container comprises heat transfer control elements having a predetermined thermal resistance to control dissipation of heat from the contents of the container.

2. The non-transitory machine-readable storage medium of claim 1, wherein the exterior of the wall of the container comprises the heat transfer control elements.

3. The non-transitory machine-readable storage medium of claim 1, wherein the heat transfer control elements comprise a heat sink.

4. The non-transitory machine-readable storage medium of claim 1, wherein the heat transfer control elements comprise air trapping features.

5. The non-transitory machine-readable storage medium of claim 1, wherein the heat transfer control elements comprise a plurality of fins.

6. The non-transitory machine-readable storage medium of claim 1, comprising instructions to select and include one of a plurality of predetermined wall designs, based on a user input corresponding to a print attribute of the printing process.

7. A 3D printing system, comprising:
a build unit, the build unit having a build chamber in which an object may be formed;
a build material distributor to distribute build material to the build chamber;
a print unit to selectively apply a fusing agent to the build material;
a fusing unit to melt the fusing agent to form a 3D object in the build chamber; and
a print control unit to control the print unit and fusing unit to form a container to contain the 3D object and non-solidified build material,
wherein a wall of the receptacle comprises heat transfer control elements having a predetermined thermal resistance.

8. The 3D printing system of claim 7, wherein the heat transfer control elements decrease a thermal resistance of the wall of the receptacle.

9. The 3D printing system of claim 7, wherein the heat transfer control elements increase a thermal resistance of the wall of the receptacle.

10. The 3D printing system of claim 7, comprising:
a secondary chamber attachable to the build unit to receive the contents of the print chamber; and
an airflow generator connectable to the secondary chamber to displace non-solidified build material between the wall of the receptacle and a wall of the secondary chamber.

11. The 3D printing system of claim 10, wherein the airflow generator is to generate a cooled airflow.

12. The 3D printing system of claim 10, wherein the airflow generator is to generate a heated airflow.

13. A method comprising:
receiving data representing a three-dimensional object model, the three-dimensional object model for use in generating a three-dimensional object in a build chamber;
modifying the received data to include a receptacle, the receptacle to contain the three-dimensional object and non-solidified build material,
wherein a wall of the receptacle comprises heat transfer control elements to regulate cooling of the 3D object.

14. The method of claim 13, wherein the exterior of the wall of the receptacle comprises the heat transfer control elements.

15. The method of claim 13, comprising selecting one of a plurality of heat transfer wall designs to prioritise a print attribute of the 3D printing method.
